(19) United States
(12) Patent Application Publication
(10) Pub. No.: US 2007/0153009 A1
(43) Pub. Date: Jul. 5, 2007

(54) Display chip sharing method

(75) Inventor: Yu-Liang Sun, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/378,150

(22) Filed: Mar. 17, 2006

(30) Foreign Application Priority Data
Dec. 29, 2005 (TW) 94147189

(51) Int. Cl. G06T 1/00; G06F 15/00

(52) U.S. Cl. 345/501

(57) ABSTRACT

A display chip sharing method allows any one of a plurality of blade servicing units of a blade server to display through the use of a switching unit electrically connected to a display device even if the blade servicing unit does not have any display chip. The method includes electrically connecting a control unit having a plug-and-play and a display chip to the switching unit and one of the blade servicing units ready to display, and having the switching unit emit an interrupt signal to the blade servicing unit; and having the blade servicing unit reset an operating system of the control unit in response to the interrupt signal, and load a driver program of the display chip, to enable the blade servicing unit to display by utilizing the display chip of the control unit in accordance with the driver program, and display processed output signals on the display device.

### BACKGROUND OF THE INVENTION

1. Field of the Invention

This invention relates to display chip sharing methods, and more particularly, to a display chip sharing method for a blade server having a plurality of blade servicing units if at least one of the blade servicing units does not have any display chip.

2. Description of Related Art

With the development of technologies, information processing devices are widely applied to every walk of life. The information processing devices, though good enough for individuals, can not satisfy the usage demands of an organization or an enterprise due to the limitation of capacity and processing capability. Therefore, to combine a plurality of information processing devices to form a resource-sharing working system is becoming a main stream in the art.

Such a resource-sharing working system has to comprise a large-scaled information processing device as a management center for controlling each of the information processing devices in the resource-sharing working system and providing resources needed by the information processing devices. The large-scaled information processing device is a server system, and the others are processors. A network in charge of the connection between the server system and the processors is called a local area network (LAN).

Take a large-scaled server system as an example. The server system comprises a plurality of independent sub-systems. Take a blade server as an example. The blade server comprises a plurality of blade servicing units. However, the blade server does not install for each of the blade servicing units a corresponding display device to display states of the blade servicing units. FIG. 1 is a functional block diagram of an application structure to which a method according to the prior art is applied. A blade server 1 comprises a plurality of blade servicing units 10, each of which has a corresponding video graphics array (VGA) chip 11. The VGA chip 11 gains control of the display device via a switch unit 12 to display the states of the blade servicing units 10 on the display device. The switching unit 12 is, for example, a keyboard/video/mouse (KVM) switcher.

However, the blade server 1 has a design flaw. The blade server 1 has to install a plurality of VGA chips 11 for each of the blade servicing units 10. Because the blade server 1 comprises only one VGA port 120, and the VGA chip 11 switches the control of each of the blade servicing units 10 on the VGA port 120 via the switching unit 12, only one VGA chip 11 is allowed to operate at any time. Therefore, the blade server 1 has a high cost due to the installation of so many VGA chips 11 for each of the blade servicing units 10.

Therefore, how to develop a method allowing the blade servicing units 10 of the blade server 1 to share an identical VGA chip to reduce the cost of the blade server 1 is becoming one of the most important issues in the art.

### SUMMARY OF THE INVENTION

In views of the above-mentioned problems of the prior art, it is a primary objective of the present invention to provide a display chip sharing method allowing each of a plurality of blade servicing units of a blade server to display even if none of the blade servicing units has a display chip.

To achieve the above-mentioned and other objectives, a display chip sharing method is provided according to the present invention. The display chip sharing method allows any one of a plurality of blade servicing units of a blade server to display through the use of a switching unit electrically connected to a display device even if the blade servicing unit does not have any display chip. The method includes electrically connecting a control unit having a plug-and-play (PnP) interface and a display chip to the switching unit and one of the blade servicing units ready to display, and having the switching unit emit an interrupt signal to the blade servicing unit; and having the blade servicing unit reset an operating system of the control unit in response to the interrupt signal, and load a driver program of the display chip, so as to enable the blade servicing unit to display through the use of the display chip of the control unit in accordance with the driver program, and display processed output signals on the display device.

The display chip sharing method further includes performing a removal process on the blade servicing unit to allow the other blade servicing units of the blade server to display. The removal process includes disconnecting the control unit from the blade servicing unit, and having the switching unit emit the interrupt signal to the blade servicing unit to enable the blade servicing unit to remove the driver program of the display chip and buses plugged to the display chip.

According to the preferred embodiment, both the control unit and the switching unit are installed in a region outside of the blade server, the PnP interface of the control unit is a peripheral component interconnect (PCI) bus, and each of the blade servicing units of the blade server comprises a PnP interface for connecting to the PnP interface of the control unit and the PnP interface of the blade servicing unit is a PCI bus.

Through the use of the display chip sharing method, the blade servicing units of the blade server are allowed to share ah identical display chip, so the cost of the blade server is reduced. Moreover, without any alteration of the blade servicing units, the blade server can display with an upgraded display chip. Therefore, the display chip sharing method of the present invention improve the system efficiency of the blade server.

### BRIEF DESCRIPTION OF DRAWINGS

The invention can be more fully understood by reading the following detailed description of the preferred embodiments, with reference made to the accompanying drawings, wherein:

FIG. 1 is a functional block diagram of an application structure to which a method according to the prior art is applied;

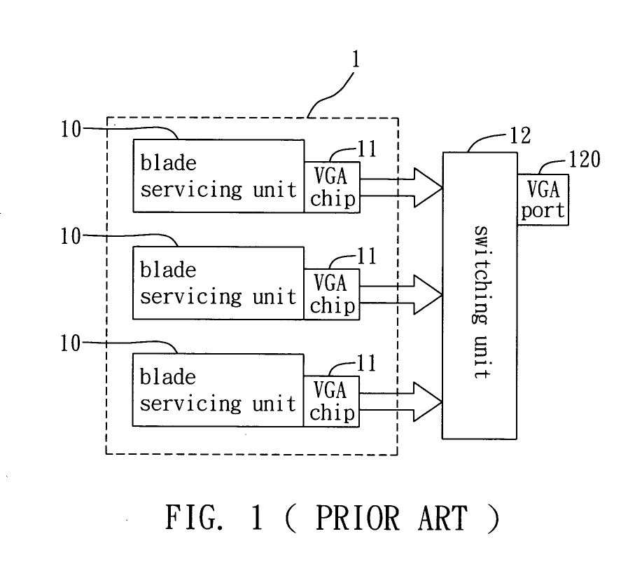

FIG. 2 is a functional block diagram of an application structure to which a display chip sharing method of the preferred embodiment according to the present invention is applied;

FIG. 3 is a flow chart of the display chip sharing method illustrating that a blade servicing unit is allowed to display even if the blade servicing unit does not have any display chip; and

FIG. 4 is a flow chart of the display chip sharing method of removing a blade servicing unit from a control unit.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

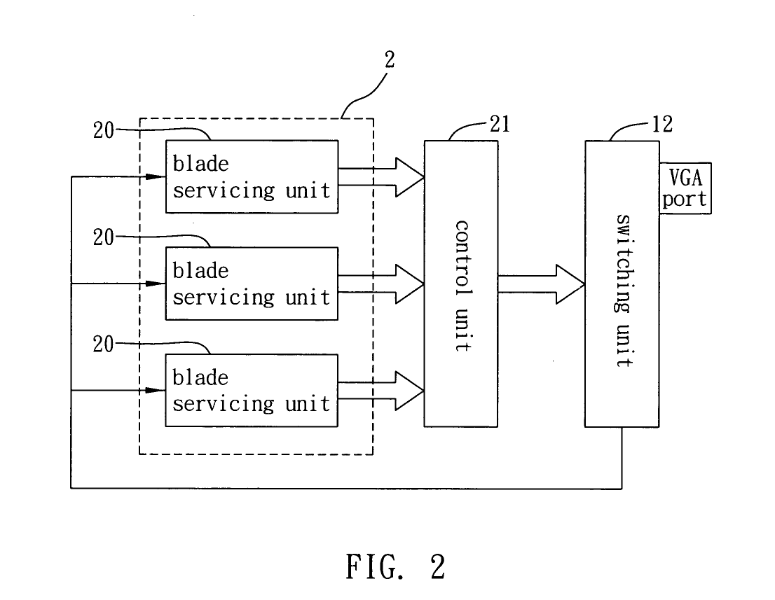

FIG. 2 is a functional block diagram of an application structure to which a display chip sharing method of the preferred embodiment according to the present invention is applied. The display chip sharing method is applied to a blade server 2 having a plurality of blade servicing units 20 if at least one of the blade servicing units 20 does not have any display chip. The method enables each of the blade servicing units 20 to display through the use of a switching unit 12 such as a keyboard/video/mouse (KVM) switcher.

Before the method is applied to the application structure, the blade server 2 has to be connected to the switching unit 12, and a control unit 21 having a plug-and-play (PnP) interface and display chip has to be connected to the switching unit 12 and one of the blade servicing units 20 ready to display. According to the preferred embodiment, the PnP interface is a peripheral component interconnect (PCI) bus. Accordingly, the blade servicing unit 20 has to comprise another PnP interface for electrically connecting to and interfacing with the control unit 21. In general, both the control unit 21 and the switching unit 12 are installed in a region outside of the switching unit 12. Moreover, because at least one of the blade servicing units 20 does not have any display chip (or none of the blade servicing units 20 has any display chip), the blade server 2 is cheap, and can get rid of the problem of too high the temperature inside of a housing in which the blade server 2 is installed due to the installation of the display chip.

Note that both the switching unit 12 and the blade server 2 are prior art, further description hereby omitted. In the following paragraphs, only those related to the display chip sharing method are described.

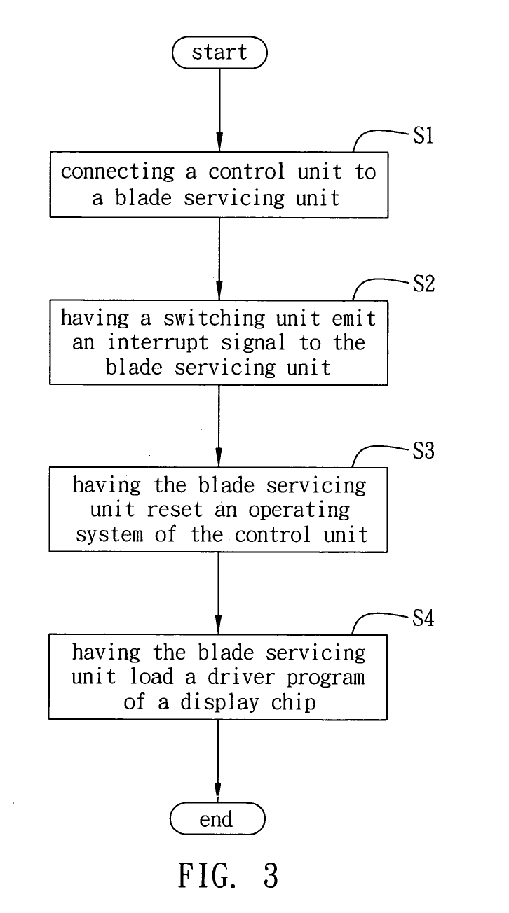

FIG. 3 is a flow chart of the display chip sharing method. The method starts in step S1. In step S1, the method connects the control unit 21, which has the PnP interface and the display chip, to the switching unit 12 and the blade servicing unit 20, which is ready to display. The method proceeds to step S2.

In step S2, the method has the switching unit 12 emit an interrupt signal to the blade servicing unit 20. The method proceeds to step S3.

In step S3, the method has the blade servicing unit 20 reset an operating system of the control unit 21 in response to the interrupt signal, so as to enable the blade servicing unit 20 to communicate with the control unit 21. The method proceeds to step S4.

In step S4, the method has the blade servicing unit 20 load a driver program of the display chip of the control unit 21, enabling the blade servicing unit 20 to display through the use of the display chip of the control unit 21 in accordance with the driver program, and to display processed output signals via the switching unit 12 on a display device.

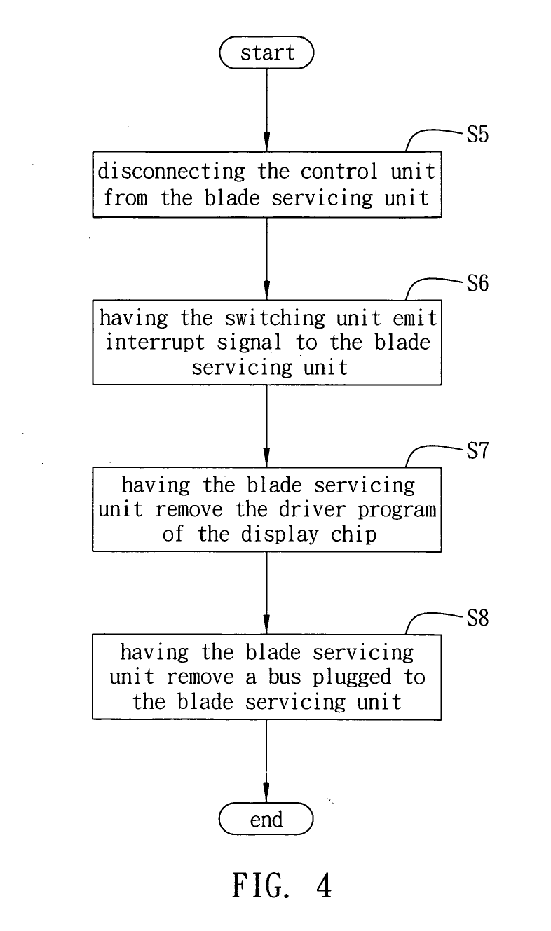

FIG. 4 is a flow chart of the display chip sharing method for removing the blade servicing unit 20 from the control unit 21, allowing the other blade servicing units 20 of the blade server 2 to display through the use of the display chip of the control unit 21. In FIG. 4 the method starts in step S5. In step S5, the method disconnects the control unit 21 from the blade servicing unit 20. The method proceeds to step S6.

In step S6, the method has the switching unit 12 emit the interrupt signal to the blade servicing unit 20, which is to be disconnected from the control unit 21 and is ready to stop displaying. The method proceeds to step S7.

In step S7, the method removes the driver program of the display chip from the blade servicing unit 20. The method proceeds to step S8. In step S8, the method further removes the bus plugged to the display chip. That is, the blade servicing unit 20 releases a transmission channel occupied the PnP interface and releases the hardware resources occupied when displaying, to restore a original order.

Through the use of the display chip sharing method, the blade servicing units of the blade server are allowed to share an identical display chip, so the cost of the blade server is reduced. Moreover, without any alteration of the blade servicing units, the blade server can display with an upgraded display chip. Therefore, the display chip sharing method of the present invention improve the system efficiency of the blade server.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A display chip sharing method allowing any one of a plurality of blade servicing units of a blade server to display through the use of a switching unit electrically connected to a display device even if the blade servicing unit does not have any display chip, the method comprising:
electrically connecting a control unit having a plug-and-play (PnP) interface and a display chip to the switching unit and one of the blade servicing units ready to display, and having the switching unit emit an interrupt signal to the blade servicing unit; and
having the blade servicing unit reset an operating system of the control unit in response to the interrupt signal, and load a driver program of the display chip, so as to enable the blade servicing unit to display through the use of the display chip of the control unit in accordance with the driver program, and display processed output signals on the display device.

2. The display chip sharing method of claim 1 further comprising performing a removal process on the blade servicing unit to allow the other blade servicing units of the blade server to display.

3. The display chip sharing method of claim 2, wherein the removal process comprises:
disconnecting the control unit from the blade servicing unit; and
having the switching unit emit the interrupt signal to the blade servicing unit to enable the blade servicing unit to remove the driver program of the display chip and a bus plugged to the display chip.

4. The display chip sharing method of claim 1, wherein both the control unit and the switching unit are installed in a region outside of the blade server.

5. The display chip sharing method of claim 1, wherein the PnP interface of the control unit is a peripheral component interconnect (PCI) bus.

6. The display chip sharing method of claim 1, wherein each of the blade servicing units of the blade server comprises a PnP interface for connecting to the PnP interface of the control unit.

7. The display chip sharing method of claim 6, wherein the PnP interface of the blade servicing unit is a PCI bus.
